(19) United States
(12) Patent Application Publication
(10) Pub. No.: US 2012/0271668 A1
(43) Pub. Date: Oct. 25, 2012

(54) Open Date Ticketing Method and System

(76) Inventor: Jake S. YUDIN, Alpharetta, GA (US)

(21) Appl. No.: 13/450,559

(22) Filed: Apr. 19, 2012

Related U.S. Application Data
(60) Provisional application No. 61/476,909, filed on Apr. 19, 2011.

(51) Int. Cl. G06Q 10/02

(52) U.S. Cl. 705/5

(57) ABSTRACT

A system and method is disclosed for selling open date ticket packages to selected events of a season of sporting or other events. A package of tickets is purchased in advance of the season with a predetermined number of open date tickets for a selected section or sections of the stadium. The tickets in the package are not date specific and not limited as to how many tickets of the package can be redeemed for attendance at a single event. During a window before each eligible event of the season, open date ticket holders may redeem tickets online for the upcoming event. One or all of the tickets of the package, or any number in between, can be redeemed for any specific event. Each redeemed ticket is assigned a seat and provided with the right to attend the event for which the open date ticket was redeemed.

### REFERENCE TO RELATED APPLICATION

Priority is hereby claimed to the filing date of U.S. provisional patent application number 61/476,909 filed on Apr. 19, 2011.

### TECHNICAL FIELD

This disclosure relates generally to ticketing for events such as sporting events, and more specifically to methods and systems for managing a flexible date or open date ticket package program for a season of events such as a season of baseball games or a season of football games.

### BACKGROUND

Many forms of “season” ticket packages to sporting events are offered by professional sports franchises and other sporting organizations. These range from plush box seats for a season to packages of only certain games such as weekend games. While there is a range of ticket package options between these extremes, virtually all options suffer from a recurring problem. All require a fan or other purchaser to make a commitment that very few can keep over a season of events—a commitment to attend events on fixed future dates that cannot easily be changed. This problem not only is frustrating and costly for purchasers and fans; it also closes off a relatively large portion of ticket sales for future games since a certain percentage of season ticket package holders will not be able to attend a given game, and this cannot be known by the organization in advance. Their seats, seats that could be re-sold and enjoyed, go unused, the purchaser is out the cost of the ticket purchased before the season began, and the organization misses the opportunity to sell unused seats to others.

Current sporting event ticketing systems simply are not capable of providing adequate flexibility to accommodate season ticket holders who are not able to attend a specific game or set of specific games within a ticket package that they may have purchased months ago. A need therefore exists for a season ticket package, method, and system that do not require a purchaser to commit far in advance to a certain number of seats for certain games on certain dates. A more general need exists for a ticketing system that does not require a purchaser of a group of tickets to commit in advance to which game or games he or she wishes to attend or the number of seats that he or she wishes to use for a specific game. It is to the provision of a method and system of ticketing, redeeming, and upgrading tickets that the present invention is primarily directed.

### SUMMARY

Briefly described, season ticketing methods systems are disclosed that open up ticket sales to potential fans who seek increased flexibility in their support commitment of a sports team or other organization. In general, the methods and systems include selling a package of tickets in advance that provides the holder of the package the choice of when and how to use the tickets. For example, a fan may purchase a package of 10 tickets that are not date specific. The fan may then redeem the tickets according to the rules of the plan for any game or games he or she wishes to attend. For instance, within a certain time window before a game, the fan may go online and redeem one or more tickets from the package for the right to attend the upcoming game. He or she may redeem only one ticket for the game, or the entire 10 tickets for the game, or any number in between. Seating assignment is handled by the system, and upgrades to more desirable sections may be available for purchase during the window. After the window closes, a number of seats corresponding to the number of open date tickets not redeemed for that game may be released for normal sale to other fans.

Thus, a system is proposed that offers complete flexibility to purchasers of season ticket packages while at the same time offering upgrades not currently available in standard season ticket packages. The system also offers the potential to sell more seats or more expensive seats to a particular event because it can be known after the time window for open date ticket redemption how many unredeemed seats are available for sale in each section. It is also believed that the open date ticket packages of the present invention will result in increased sales of season tickets in advance of a season. The system also lends itself to the creation of a gift market that is much more flexible than current ticketing schemes. Companies or individuals, for example, can purchase a ticket package or packages and give packages or individual open date tickets within a package as gifts to clients or others without being concerned that the recipient may not be available for particular games. Finally, rained-out games are much easier to handle. If a game is rained-out, then open date tickets that were redeemed for that game are simply transferred back to the ticket package owner's pool and can be used for the make-up game or for any other game in the future. All of this is done electronically and automatically through a domain or domains on the Worldwide Web. These and other features, aspects, and advantages of the ticketing system and methodology of this invention will become more apparent upon review of the detailed description presented below.

### DETAILED DESCRIPTION

A ticketing method and system is disclosed that involves selling a package of tickets in advance with each ticket of the package being usable when and how the package holder decides in the future to use them. The tickets of the package are generally referred to herein as “open date tickets.” For instance, a holder of a ticket package may decide to use several or even all tickets of the package for one single game if it is desired to take friends and family along to the game. Alternatively, only a single ticket of the package may be used for a game where only the package holder or another individual wants to attend alone. This option may exist within the package for each game of the season (or, more likely, each home game), for selected blocks of games, for selected time periods, etc. so that a package holder can redeem tickets of the package in the numbers and for the game dates of his or her choice within package parameters. The system and method preferably is web-based and managed and includes a time window just prior to each game of the season during which open date ticket package holders can redeem one or more tickets of their package for the upcoming game. Preferably, redemption takes place online through a domain on the Worldwide Web, with ticket package holders going to a website and indicating the tickets of their packages that are being redeemed for the upcoming game. While this creates needed flexibility for the ticket package holders, it also creates favorable opportunities for the stadium or sports organization. For instance, after the time window for open date ticket redemption, the stadium knows rather precisely how many open date tickets will be used to fill seats at the game in each seating section. More importantly, the stadium also knows how many open date tickets have not been redeemed in each section and thus how many of those seats will not be occupied by open date ticket holders at the game. The unoccupied seats can then be sold at the gate or announced as available on the radio, or otherwise disposed of to other fans. Alternatively, some of the open date ticket seats presumably will have been purchased for more desirable sections of the stadium. After the redemption window, non-redeemed seats in the more desirable sections can be offered for sale as upgrades to other season ticket holders, given as concessions, or used in another profitable manner by the organization.

In one specific embodiment of the invention, an open date ticket package can be sold in advance of a season of events with a predetermined number of event attendances included in the package. There may, for instance, be 5, 10, 15, 25, or more event attendances included in a package for a commensurate price. Importantly, the purchaser does not purchase specific games to be attended by a specific number of people, but rather a specific number of attendances at one or more games in the future. For example, a 10 ticket open date ticket package may be used by 10 people to attend one game in the future, or by one person to attend 10 games in the future, or any combination in between.

At the time of purchase (which preferably is via the Internet), the purchaser is required to establish an online account through which he or she may manage, redeem, and/or upgrade the open date tickets of a purchased package. Prior to each game of the season, a time window or a time deadline is established. Before the end of the window or deadline, open date ticket holders can redeem tickets for the corresponding game if they wish to attend that game. After the window or deadline, open date tickets can only be redeemed if there are still open date seats available in the stadium or other venue. This might happen, for instance, at the gate, where an open date ticket may be presented and its holder either allowed admission or not depending upon whether non-redeemed open date seats are still available. Preferably for the stadium, however, the non-redeemed seats will have been re-sold after the time window or deadline, thus increasing revenue and profits for the organization sponsoring the event.

At the time of purchase, an open date ticket package may be purchased for a particular class of seats. For example, the package may be for field level seats, terrace level seats, upper level seats, etc. Some levels obviously are more desirable (and more valuable) than others because of their proximity to the game and the players. Packages for seats in more desirable levels are priced correspondingly higher than packages for seats in less desirable levels. Further, at the time that an open date ticket is redeemed online during the redemption window, a ticket package holder may be given the opportunity to upgrade to a seat in a more desirable section of the stadium at a prorated price. The offer of an upgrade and price can be based upon the probability that a seat in the upgraded section will be sold prior to the game, based upon the amount of availability in the upgraded section, how soon the game is to begin, historical last minute sales information, and the like. If an upgrade is offered, accepted, and paid for, the ticket package holder will be assigned a seat in the more desirable section, that seat will be removed from the list of available seats in that section, and a seat in the section for which the ticket package was originally purchased is released for redemption by another open date ticket holder or purchase through normal ticketing channels. Thus, the ticket package holder gets the occasional upgrade, the organization realizes incremental income from the more desirable seat, and the organization is able to resell or redeem the seat left behind in the original section.

Open date ticket package holders will be provided a predetermined time window or a predetermined deadline before each eligible game that preferably remains consistent throughout the season and before the end of which open date tickets must be redeemed. Certain restrictions exist to safeguard against any potential problems created while interfacing with the current ticket systems in place, and to ensure that there is no interference with other standard ticket sales. Open date tickets can be given, exchanged, and traded freely, so long as the eventual holder redeems the thicket before the end of the time window or deadline. Preferably, the open date tickets are scannable and can be scanned at the gate, with the ticketing computer approving the open date ticket for admission and assigning a specific seat if it has been properly redeemed. Alternatively, actual tickets corresponding to redeemed open date tickets can be printed and made available at will call, at the gate, or at another location.

The open date ticketing system and method of this invention also gives rise to a newly vitalized gift market for ticket packages. Under current pre-selected game date packages, it is very difficult to give tickets to clients or others very far in advance of a game because it must be confirmed that the recipient is indeed available to attend the game to which tickets are being given. With the system of this invention, however, entire open date ticket packages for a season, a group of games, a time period during a season, or individual tickets from such packages can easily be gifted without concern whether the recipient is available for a particular game or not. The recipient can choose any game he or she wishes to use the gifted tickets for. Accordingly, it is expected that ticket sales with increase due to the creation of a viable and flexible gift market for open date ticket packages.

Rained-out games currently are difficult and expensive to handle in terms of managing the tickets of fans that were to attend a game that was rained-out. Further, the rain checks provided to fans are usually only good for the rescheduled make-up game and many times a fan is not available to attend the make-up game. The system and method of this invention resolves these issues. If a game to which an open date ticket has been redeemed is rained-out, the open date ticket option is simply returned to the pool of the ticket package holder. The package holder can then re-redeem it for attendance at the scheduled make-up game or use it in the usual way to attend any other game within package parameters in the future. All of this is handled electronically and automatically so that managing attendance at a rained-out game is simple, easy, and automatic. Further, if open date tickets are not redeemed for the scheduled make-up game, then more seats can be sold to the make-up game at the gate, which may be advantageous particularly for popular match-ups.

The ticketing system of this invention most preferably is managed by software that controls the website of the plan at a hosted domain on the Worldwide Web, the online accounts of package holders, the management, redemption, and upgrading of open date tickets, the release and resale of unredeemed or otherwise available seats, the approval of open date tickets for admission at the gate (or the printing of actual tickets upon presentation of a redeemed open date ticket), and all of the other functions of the system.

The core concept of the system described above creates opportunities for sports organizations to offer ticketing packages to fans that will allow the fans to buy a group of tickets without having to commit to particular dates or number of attendees at the time of purchase. Another aspect of the invention addresses issues surrounding normal variations in prices of tickets per game (e.g. weekend game tickets may be more expensive then weekday game tickets), the different needs of organizations that exist within the league such as varying market sizes, and the need to quantify the maximum number of open date ticket packages can be sold without selling more tickets than there are seats available. To address such issues, the invention includes the creation of customizable open date ticket packages that can be customized by the purchaser on line at the time of purchase. Once the purchaser customizes a package he or she wishes to purchase, both the price of the open date ticket package and the number of seats available after the purchase can be determined.

Obviously, an organization cannot issue more tickets, including regular tickets and open date tickets, than it has seats available for any particular game. The system of the present invention addresses this real world limitation with the novel concept that the number of total available seats is based upon the total number of tickets available throughout the duration of a particular open date ticket package (e.g. an entire season, the first half of the season, weekend games only, etc.). For example, assume that the number of total tickets available throughout the season in a certain section of the stadium is X. Open date ticket packages for the season can be sold until the sum of existing physical tickets available in that section plus the number of open date tickets that are able to be redeemed in that section is equal to X. This means that if an organization obtains combined sales of physical and open date tickets of X for a section during the entire season, then sufficient tickets, both real and open date, have been issued to sell out the entire section for every game the season.

Such a “season sell out” condition for a particular section of the stadium does not prevent an organization from continuing to sell traditional tickets in such a “sold out” section. It only prevents the sale of additional open date ticket packages with seats that can be redeemed in that section. Since the redemption period for seats from open date ticket packages preferably ends prior to the beginning of ticket sales on the day of the game, all open date ticket seats in a “sold out” section that were not redeemed can be purchased by fans at the gate. This allows the organization to maximize profit for available seats in the section for each game, and, theoretically, exceed the profits that would be generated by 100% attendance. Furthermore, the organization may apply dynamic pricing for the existing seats in a section that were not redeemed to increase profits even more. For example, an organization may alter the prices at the gate when the ticket office opens in order to increase the likelihood that more valuable seats are sold.

In another aspect of the invention related to upgrading and account management, each open date ticket represents a real dollar amount that is equal to the average of cost of a ticket in the plan. For instance, if the total cost of tickets in an open date ticket package is $100.00, and the purchaser purchased additional options (e.g. upgrades) that made the total cost of the package $120.00, then the assigned value of each open date ticket in the package is $12.00. If the purchaser or a fan wants to upgrade one of the open date tickets for a particular game to a seat that costs $25.00 without using an upgrade option in the package, then the assigned $12.00 value of the open date ticket for the game is deducted from the upgraded seat price and the purchaser or fan can pay the difference to upgrade one or more tickets in the open date ticket package.

In another aspect of the invention, options to choose open date ticket packages may be set up to supplement current ticketing packages and ticketing as generally described above. Alternatively, however, the open date ticketing system of the present invention may be established as the sole or primary mechanism for offering ticketing in multi-game ticket packages.

The features, options, controls, and restrictions that are offered to purchasers will most likely be directly related to the attendance an organization projects. For example, the smaller the attendance or expected attendance at a particular game, or the smaller the attendance at a particular stadium or for a particular franchise, the fewer restrictions need be implemented and the options for upgrades, etc, can be commensurately greater.

### EXAMPLES

Following are some examples of open date ticketing options that may be implemented by an organization such as a sports franchise according to the invention disclosed herein depending upon the circumstances and needs of the organization.

### Example Option 1

In this example option, open date ticket package purchasers may select not only how many open date tickets they wish to purchase in a package, and the section or sections of the stadium to which those tickets apply, but also will specify the months during which they will redeem their tickets. For instance, a package purchaser may specify April, May, and/or June, which usually see lower attendance, or July, August, and/or September, which traditionally are associated with higher attendance. The price of the open date ticket package is then determined with, for example, lower attendance month packages costing less and higher attendance months costing more. Further, depending on the size of the market a team plays in, various sub-options within the package may be offered such as Weekday games only, Weeknight games only,

Weekend games only, or all games during the selected months. The cost of the purchaser customized open date ticket package can then be determined based upon an assigned value of tickets to games within the selected windows.

According to another aspect, if a purchaser buys a predetermined number of open date tickets in a package (e.g. 100 tickets) they may be considered “premium” package holders and automatically be given the benefit of a specified redemption deadline for tickets in the package that is later than the standard redemption deadline. For example, if the standard redemption deadline for open date tickets is 11:59 p.m. the night before a game, premium package holders may take advantage of a later redemption time of, for instance, 4:00 p.m. the day of a game for a night game or 10:00 a.m. the day of the game for day games. In addition, purchasers of non-premium packages may be given the option to purchase the ability to redeem tickets later than the standard redemption time, thereby increasing revenue to an organization from those non-premium packages. Alternatively, some organizations in markets with traditionally lower attendance may want to increase attendance by offering all open date ticket package holders a late redemption deadline. Combinations of these features and options also may be implemented.

### Example Option 2

Since one goal of the methods and system of this invention is to create more flexibility, sometimes selecting a period of three months may not be considered sufficiently flexible. To address this, another option for an organization is to permit or offer within the system purchasers to select a list of games they may or expect to want to attend during the season. In such an option, there preferably is a dollar amount for every game that is available to be redeemed and the package is priced accordingly. Teams with higher traditional attendance can apply dynamic pricing models that determine which games are expected to be of greater value and the cost of the “game specific” package is set according to the values of the selected games. Of course, the tickets of the package do not have to be redeemed for all of the selected games since they still retain their “open date” characteristics. The can, for instance, all be redeemed for one of the selected games or any combination of the selected games.

For example, a purchaser may purchase an open date ticket package of 100 tickets to be used over the course of a season of 81 home games. The purchaser plans on being on vacation for certain weeks in June, and July. So, the purchaser selects the games that he or she may want to attend that do not include any games during the time he or she expects to be on vacation. Depending upon the organization and historical attendance and pricing, the cost of the ticket package may vary as a function of the games selected even though the number of tickets and the section of the stadium selected may be the same as lower priced ticket packages.

### Example Option 3

In another aspect of the invention, an organization may create “Value Packs” to supplement existing forms of ticket packages. For instance, the organization may select a collection of their historically lowest attended games and offer discounts for the cost of an open date ticket package including these games. The discounted packages may be added to regular priced open date ticket packages, offered as stand alone packages, or offered as supplements to traditional fixed date ticket packages. They may also be offered as incentives to encourage purchasers to buy larger packages of regular or open date ticket packages. For example, every 20 open date tickets added to a package of open date tickets may increase the discount made available for the entire package.

In another aspect of the invention, automated open date tickets may be created using information provided by purchasers when packages are purchased and the tickets redeemed, in conjunction with general and historical attendance information. The system of the invention can, for instance, evaluate consumer behavior, predict future trends based upon such evaluation, and automatically develop open date ticket packages that better suit the needs and tendencies of purchasers and that, with more certainty, maximize revenues to the organization. In addition, the wealth of data generated by the system during use may be used to enhance the relationship between sports organizations and their ticket purchasers and fans.

The invention has been described herein generally within the context of ticket packages to a season of sports events such as a baseball season or a football season. However, the invention is not so limited and may be applied to any type of season that consists of a number of events. For example, the system may be applied to a symphony season, a concert season, a racing season, a series of seminars, a series of classes on various topics, or any other group of events with respect to which attendees may want flexibility in attendance dates. Furthermore, paper tickets need not be involved at all. The open date tickets can be completely virtual with an actual ticket being printed and made available at will call or elsewhere only with an open date ticket is redeemed. These and other additions, deletions, and modifications might well be made to the embodiments described above without departing from the spirit and scope of the invention represented thereby.

What is claimed is:

1. A ticketing method comprising the steps of:
(a) purchasing a package of one or more open date tickets to a series of individual events in a group of events;
(b) deciding whether attendance at a specific event of the group of events is desired;
(c) at a predetermined time before the specific event, redeeming one or more of the open date tickets for the right to attend the specific event if it is decided in step (b) that attendance is desired.

2. The ticketing method of claim 1 and further comprising receiving an offer to upgrade seating for the specific event and accepting the offer if desired.

3. The ticketing method of claim 1 wherein step (a) comprises logging onto a domain on the Worldwide Web.

4. The ticketing method of claim 1 and further comprising the step (d) of attending the event.

5. The ticketing method of claim 1 wherein step (a) comprises selecting among available packages each comprising open date tickets to selected groups of events and purchasing the selected package.

6. The ticketing method of claim 5 wherein the available packages include a package of events occurring during one or more time periods.

7. The ticketing method of claim 5 wherein the available packages include a package of events occurring during weekdays.

8. The ticketing method of claim 5 wherein the available packages include a package of events occurring weekends.

9. The ticketing method of claim 5 wherein the available packages include a package of events occurring during the evening.

10. The ticketing method of claim 1 further including the step of gifting the purchased package of one or more open date tickets.

11. A method of selling seats at a selected event of a series of events, the method comprising the steps of:
(a) offering open date ticket packages to purchasers, the packages comprising at least one package that includes one or more open date tickets that may be redeemed for the right to attend the selected event.
(b) receiving value from a purchaser in exchange for the at least one package;
(c) establishing a redemption deadline prior to the selected event by which open date tickets may be redeemed for the right to attend the selected event;
(d) receiving a request to redeem the one or more open date tickets from step (a) by the deadline established in step (c); and
(e) providing the right to attend the selected event in exchange for each of the one or more open date tickets for which a request to redeem is received in step (d).

12. The method of claim 11 further comprising establishing prior to the redemption deadline a number of seats at a venue of the event that are allocated to open date tickets to be redeemed in step (d).

13. The method of claim 12 further comprising determining after the redemption deadline if the number of seats allocated to open date tickets exceeds the number of open date tickets redeemed and offering for sale at least some of the seats in excess of the number of open date tickets redeemed.

14. The method of claim 11 further comprising offering an upgrade to a more desirable seat in exchange for value.

15. The method of claim 11 wherein step (d) comprises receiving the request through a domain on the Worldwide Web.

16. The method of claim 11 wherein step (e) comprises issuing a traditional ticket in exchange for the open date ticket for which a request to redeem is received in step (d).

17. The method of claim 11 wherein step (e) comprises providing the right to attend to the purchaser.

18. The method of claim 11 wherein step (e) comprises providing the right to attend to someone other than the purchaser.

19. The method of claim 18 wherein the someone other than the purchaser is a recipient of a gift from the purchaser.
